(19) United States
(12) Patent Application Publication
(10) Pub. No.: US 2013/0105399 A1
(43) Pub. Date: May 2, 2013

(54) POLYMER-ENCAPSULATED LIQUID EXCHANGE MEDIA

(71) Applicants: Lawrence Livermore National Security, LLC, Livermore, CA (US); University of Illinois Urbana Champaign, Champaign, IL (US)

(72) Inventors: Roger D. Aines, Livermore, CA (US); William L. Bourcier, Livermore, CA (US); Eric B. Duoss, Dublin, CA (US); Christopher M. Spadaccini, Oakland, CA (US); Joshuah K. Stolaroff, Oakland, CA (US); Jennifer A. Lewis, Urbana, IL (US); Elizabeth M. Glogowski, Eau Claire, WI (US); John J. Vericella, Oakland, CA (US)

(73) Assignees: University of Illinois Urbana Champaign, Champaign, IL (US); Lawrence Livermore National Security, LLC, Livermore, CA (US)

(21) Appl. No.: 13/666,781

(22) Filed: Nov. 1, 2012

Related U.S. Application Data
(60) Provisional application No. 61/554,591, filed on Nov. 2, 2011.

(51) Int. Cl. C02F 5/10; C02F 1/42; B01D 15/04

(52) U.S. Cl. 210/687; 210/660; 252/179

(57) ABSTRACT

A capsule for encapsulating ion exchange chemicals has a capsule body, including a surface layer and ion exchange chemicals encapsulated within said surface layer. An ion exchange media is created by encapsulating liquid ion exchange chemicals inside a polymer coat making small beads which behave as solids but have much higher exchange capacity. The improved capacity is up to twice that of existing media.

### CROSS-REFERENCE TO RELATED APPLICATIONS

This application claims benefit under 35 U.S.C. §119(e) of U.S. Provisional Patent Application No. 61/554,591 filed Nov. 2, 2011 entitled “polymer-encapsulated liquid ion exchange media,” the disclosure of which is hereby incorporated by reference in its entirety for all purposes.

U.S. patent application Ser. No. 13/312,418 filed Dec. 6, 2011 by Roger D. Aines, Christopher M. Spadaccini, Joshuah K. Stolaroff, William L. Bourcier, Jennifer A. Lewis, Eric B. Duoss, John J. Vericella for separation of a target substance from a fluid or mixture using encapsulated sorbents discloses systems related to the present invention. Roger D. Aines, William L. Bourcier, Eric B. Duoss. Christopher M. Spadaccini, Joshuah K. Stolaroff, Jennifer A. Lewis, and John J. Vericella are inventors named in the present application. The disclosure of U.S. patent application Ser. No. 13/312,418 filed Dec. 6, 2011 by Roger D. Aines, Christopher M. Spadaccini, Joshuah K. Stolaroff, William L. Bourcier, Jennifer A. Lewis, Eric B. Duoss, John J. Vericella for separation of a target substance from a fluid or mixture using encapsulated sorbents is incorporated herein in its entirety for all purposes by this reference.

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### BACKGROUND

1. Field of Endeavor

The present invention relates to ion exchange media and more particularly to polymer-encapsulated liquid ion exchange media.

2. State of Technology

Beads with Ion-Exchange Resin

An ion-exchange resin or ion-exchange polymer is an insoluble matrix (or support structure) normally in the form of small (1-2 mm diameter) beads, usually white or yellowish, fabricated from an organic polymer substrate. The material has a highly developed structure of pores on the surface of which are sites with easily trapped and released ions. The trapping of ions takes place only with simultaneous releasing of other ions; thus the process is called ion-exchange. There are multiple different types of ion-exchange resin which are fabricated to selectively prefer one or several different types of ions.

Ion-exchange resins are widely used in different separation, purification, and decontamination processes. The most common examples are water softening and water purification. In many cases ion-exchange resins were introduced in such processes as a more flexible alternative to the use of natural or artificial zeolites.

Most typical ion-exchange resins are based on crosslinked polystyrene. The required active groups can be introduced after polymerization, or substituted monomers can be used. For example, the crosslinking is often achieved by adding 0.5-25% of divinylbenzenc to styrene at the polymerization process. Non-crosslinked polymers are used only rarely because they are less stable. Crosslinking decreases ion-exchange capacity of the resin and prolongs the time needed to accomplish the ion exchange processes. Particle size also influences the resin parameters; smaller particles have larger outer surface, but cause larger head loss in the column processes.

Besides being made as bead-shaped materials, ion exchange resins are produced as membranes. The membranes, which are made of highly cross-linked ion exchange resins that allow passage of ions, but not of water, are used for electrodialysis.

Water Softening

In this application, ion-exchange resins are used to replace the magnesium and calcium ions found in hard water with sodium ions. When the resin is fresh, it contains sodium ions at its active sites. When in contact with a solution containing magnesium and calcium ions (but a low concentration of sodium ions), the magnesium and calcium ions preferentially migrate out of solution to the active sites on the resin, being replaced in solution by sodium ions. This process reaches equilibrium with a much lower concentration of magnesium and calcium ions in solution than was started with.

The resin can be recharged by washing it with a solution containing a high concentration of sodium ions (e.g. it has large amounts of common salt (NaCl) dissolved in it). The calcium and magnesium ions migrate off the resin, being replaced by sodium ions from the solution until a new equilibrium is reached. The salt is used to recharge an ion-exchange resin which itself is used to soften the water.

Water Purification

In this application, ion-exchange resins are used to remove poisonous (e.g. copper) and heavy metal (e.g. lead or cadmium) ions from solution, replacing them with more innocuous ions, such as sodium and potassium.

Few ion-exchange resins remove chlorine or organic contaminants from water. This is usually done by using an activated charcoal filter mixed in with the resin. There are some ion-exchange resins that do remove organic ions, such as MIEX (magnetic ion-exchange) resins. Domestic water purification resin is not usually recharged—the resin is discarded when it can no longer he used.

Production of High Purity Water

Water of highest purity is required for electronics, scientific experiments, production of superconductors, and nuclear industry, among others. Such water is produced using ion-exchange processes or combinations of membrane and ion-exchange methods. Cations are replaced with hydrogen ions using cation-exchange resins; anions are replaced with hydroxyls using anion-exchange resins. The hydrogen ions and hydroxyls recombine producing water molecules. Thus, no ions remain in the produced water. The purification process is usually performed in several steps with “mixed bed ion-exchange columns” at the end of the technological chain.

Ion-Exchange in Metal Separation

Ion-exchange processes are used to separate and purify metals, including separating uranium from plutonium and other actinides, including thorium; and lanthanum, neodymium, ytterbium, samarium, lutetium, from each other and the other lanthanides. There are two series of rare earth metals, the lanthanides and the actinides. Members of each family have very similar chemical and physical properties. 1on-exchange was for many years the only practical way to separate the rare earths in large quantities. This application was developed in the 1940s by Frank Spedding. Subsequently, solvent extraction has mostly supplanted use of ion exchange resins except for the highest purity products.

A very important case is the PUREX process (plutonium-uranium extraction process) which is used to separate the plutonium and the uranium from the spent fuel products from a nuclear reactor, and to be able to dispose of the waste products. Then, the plutonium and uranium are available for making nuclear-energy materials, such as new reactor fuel and nuclear weapons.

Ion-exchange heads are also an essential component in In-situ leach uranium mining. In-situ recovery involves the extraction of uranium-bearing water (grading as low as 0.05% U308) through boreholes. The extracted uranium solution is then filtered through the resin beads. Through an ion exchange process, the resin beads attract uranium from the solution. Uranium loaded resins are then transported to a processing plant, where U308 is separated from the resin beads and yellowcake is produced. The resin heads can then be returned to the ion exchange facility where they are reused.

The ion-exchange process is also used to separate other sets of very similar chemical elements, such as zirconium and hafnium, which incidentally is also very important for the nuclear industry. Zirconium is practically transparent to free neutrons, used in building reactors, but hafnium is a very strong absorber of neutrons, used in reactor control rods.

Juice Purification

Ion-exchange resins are used in the manufacture of fruit juices such as orange juice where they are used to remove bitter tasting components and so improve the flavor. This allows poorer tasting fruit sources to be used for juice production.

Sugar Manufacturing

Ion-exchange resins are used in the manufacturing of sugar from various sources. They are used to help convert one type of sugar into another type of sugar, and to decolorize and purify sugar syrups.

Pharmaceuticals

Ion-exchange resins are used in the manufacturing of pharmaceuticals, not only for catalyzing certain reactions but also for isolating and purifying pharmaceutical active ingredients. Three ion-exchange resins, sodium polystyrene sulfonate, colestipol, and cholestyramine, are used as active ingredients. Sodium polystyrene sulfonate is a strongly acidic ion-exchange resin and is used to treat hyperkalemia.

Colestipol is a weakly basic ion-exchange resin and is used to treat hypercholesteroleinia. Cholestyramine is a strongly basic ion-exchange resin and is also used to treat hypercholesterolemia. Colestipol and cholestyramine are known as bile acid sequestrants.

Ion-exchange resins are also used as excipients in pharmaceutical formulations such as tablets, capsules, and suspensions. In these uses the ion-exchange resin can have several different functions, including taste-masking, extended release, tablet disintegration, and improving the chemical stability of the active ingredients.

United States Published Patent Application No. 2011/0163038 for methods for hydrodynamic control of a continuous water purification system includes the state of technology information reproduce below. The disclosure of United States Published Patent Application No. 2011/0163038 is incorporate herein by this reference.

As described in Perry's Chemical Engineers' Handbook, 7.sup.th ed., chapter 16, page 14, and in Kirk-Othmer's Encyclopedia of Separation Technology, Vol. 2, pages 1074-1076, commercially available ion exchange media are selective and will remove divalent and multivalent cations in preference to monovalent cations. When ion exchange media are employed in conventional fixed or moving bed reactors, divalent cations will be removed to a greater extent than the monovalent cations. Divalent cations, even in low concentrations, will replace monovalent cations on the ion exchange media. Consequently, commercially available produced water treatment schemes that use cation exchange media for sodium removal (e.g., treatment schemes employing Higgins Loop and fixed bed treatment technologies) also quantitatively remove calcium and magnesium. Restoring divalent cations to the solution adds to process complexity and requires conditioning of treated water by chemical addition or mineral contacting plus blending of treated and untreated water streams.

The selectivity of cation exchange media for calcium and magnesium over sodium and potassium has been the major impediment to simple, economical, single contact treatment of sodic water by ion exchange.

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a new form of ion exchange media created by encapsulating liquid ion exchange chemicals inside a polymer coat, making small beads which behave as solids but have much higher exchange capacity, up to twice that of existing media. In one embodiment the beads are 200 to 500 pm in diameter and have a porous shell composed of a variety of different polymers. The ability to encapsulate a wide variety of liquids makes it possible to create new kinds of ion exchange media in addition to higher capacity forms of existing media.

The present invention has use in water purification, water softening, purifying metals including radionuclides, making very high purity water for reactors and boilers, purifying pharmaceuticals, refining sugar and food additives, specialized purification processes such as refining metals and radionuclides, carbon dioxide sequestering, and other uses.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1A is an illustration of a prior art porous bead.

FIG. 1B is an enlarged and exaggerated section of the prior art porous bead shown in FIG. 1A.

FIG. 2 illustrates an embodiment of a microcapsule of the present invention.

FIG. 3 illustrates a system for making polymer coated microcapsules.

FIG. 4 illustrates a water softening system using Applicant's microcapsules that encapsulate liquid ion exchange chemicals inside a polymer coat.

FIGS. 5A-5D illustrate a column system using Applicant's microcapsules that encapsulate liquid ion exchange chemicals inside a polymer coat making small beads which behave as solids but have much higher exchange capacity.

### DETAILED DESCRIPTION OF SPECIFIC EMBODIMENTS

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

The present invention provides a new form of ion exchange media created by encapsulating liquid ion exchange chemicals inside a polymer coat, making small capsules which behave as solids but have much higher exchange capacity, up to twice that of existing media. The term “capsule” or “capsules” when used in this application means: capsule or capsules or bead or beads or pebble or pebbles or pellet or pellets or particle or particles or other similar term.

The ability to encapsulate a wide variety of liquids makes it possible to create new kinds of ion exchange media in addition to higher capacity forms of existing media. The present invention provides a new form of ion exchange media that can be used in water purification, water softening, purifying metals including radionuclides, making very high purity water for reactors and boilers, purifying pharmaceuticals, refining sugar and food additives, specialized purification processes such as refining metals and radionuclides, carbon dioxide sequestering, and other uses.

Prior Art Porous Bead

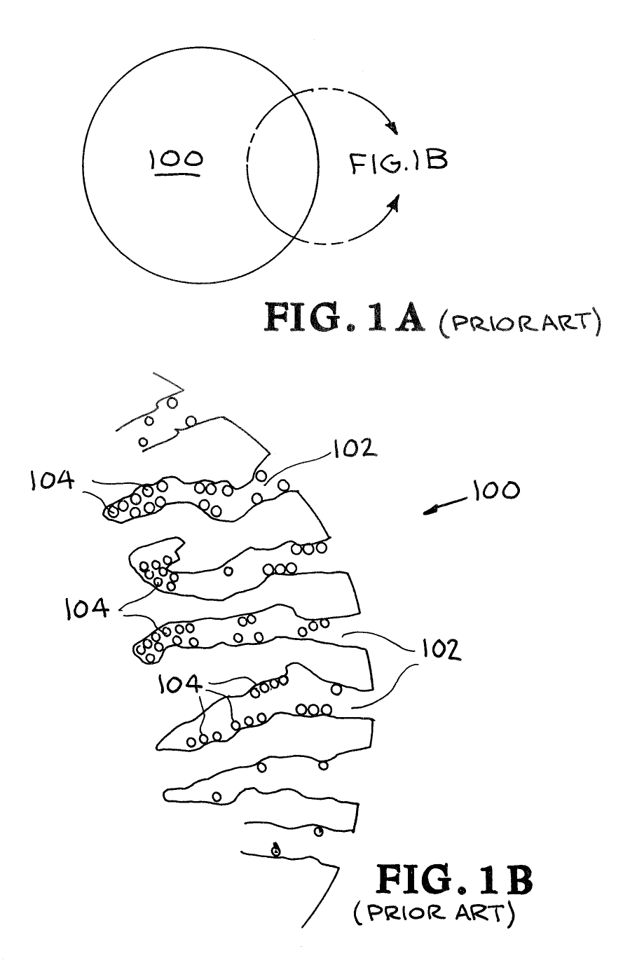

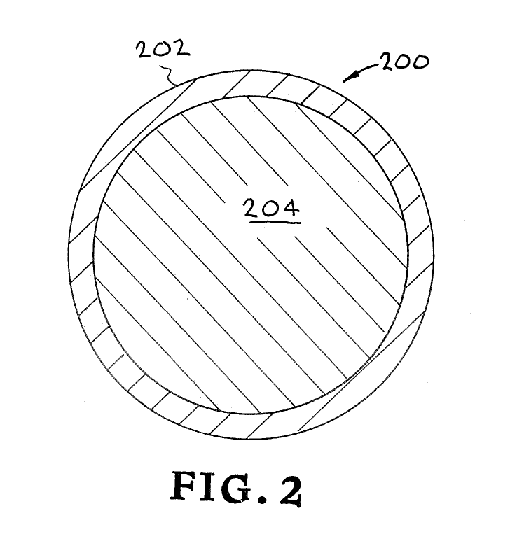

Referring now to the drawings and in particular to FIGS. 1A and 1B a prior art porous bead is illustrated. The prior art porous bead is designated generally by the reference numeral 100 in FIGS. 1A and 1B. FIG. 1B illustrates the prior art porous bead 100 and FIG. 1B is an enlarged and exaggerated section of the prior art porous bead 100 shown in FIG. 1A.

The prior art porous bead 100 provides an insoluble matrix (or support structure) normally in the form of small (1-2 mm diameter) beads fabricated from an organic polymer substrate. The material has a highly developed structure of pores 102 on the surface of which are sites with easily trapped and released ions 104. The trapping of ions takes place only with simultaneous releasing of other ions; thus the process is called ion-exchange. There are multiple different types of ion-exchange resin which are fabricated to selectively prefer one or several different types of ions.

Ion-exchange resins are widely used in different separation, purification, and decontamination processes. The most common examples are water softening and water purification. In many cases ion-exchange resins were introduced in such processes as a more flexible alternative to the use of natural or artificial zeokites. Most typical ion-exchange resins are based on crosslinked polystyrene. The required active groups can be introduced after polymerization, or substituted monomers can be used. For example, the crosslinking is often achieved by adding 0.5-25% of divinylbenzene to styrene at the polymerization process. Non-crosslinked polymers are used only rarely because they are less stable. Crosslinking decreases ion-exchange capacity of the resin and prolongs the time needed to accomplish the ion exchange processes. Particle size also influences the resin parameters; smaller particles have larger outer surface, but cause larger head loss in the column processes.

Microcapsules

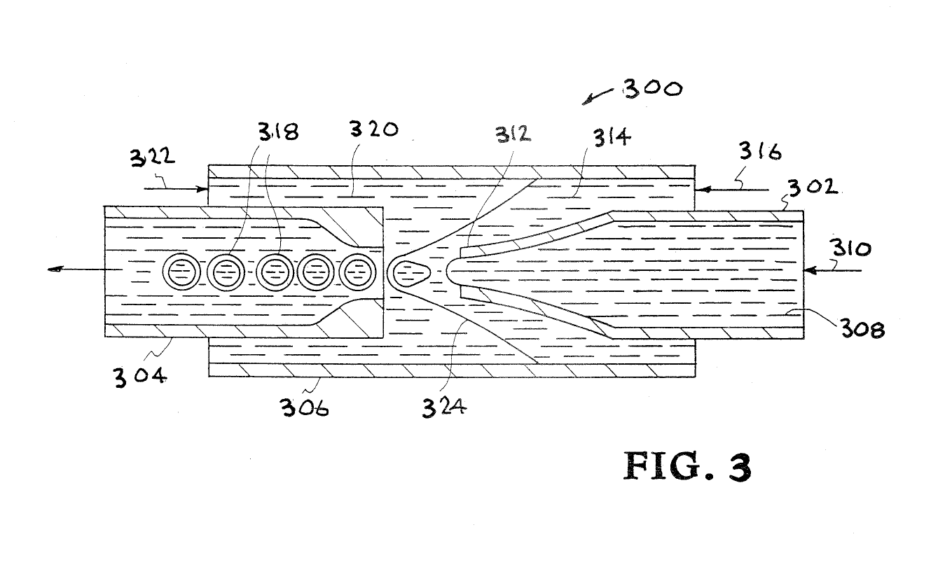

Referring now to the drawings and in particular to FIG. 2, an embodiment of a microcapsule of the present invention is illustrated. The microcapsule is designated generally by the reference numeral 200. The microcapsule 200 encapsulates liquid ion exchange chemicals inside a polymer coat making small beads which behave as solids but have much higher exchange capacity. The present invention provides a new form of ion exchange media created by encapsulating liquid ion exchange chemicals inside a polymer coat, making microcapsule 200, which behave as solids but have much higher exchange capacity, up to twice that of existing media. Another advantage of the microcapsule 200 encapsulates liquid ion exchange chemicals is reaction kinetics. The conventional resins are limited in rate of uptake by hindered movement through the porous channel ways inside the polymer bead. Having free liquid inside the microcapsules 200 allows free advection (mixing) and makes overall kinetics much faster. Another advantage is that the microcapsule 200 encapsulates liquid ion exchange chemicals is not limited to solvents/liquids that can be chemically bonded to polystyrene. Pure liquids can be contained inside the microcapsule 200 encapsulates liquid ion exchange chemicals as long as they are not reactive with the polymer shell material. The polymer coat is made of various polymers including polymers made of Poly(1-trimethylsilyl propyne), Vinyl alcohol/acrylate copolymer, Polydimethylsiloxane (PDMS), Teflon AF, Polyimide with 6FDA groups, Cellulose acetate, and Poly(vinyl alcohol). Applicant's preferred polymer shell is a material similar to that used in electrodialysis membranes that is permeable to ions but not to water.

The microcapsule 200 of this embodiment is 200 to 500 pm in diameter. The polymer surface layer 202 is optimally less than 10 microns thick. The polymer surface layer 202 is made of any of several families of polymers, including polystyrene, polyethylene, polypropylene, nylon, and others. The microcapsule 200 includes liquid ion exchange chemicals 204 encapsulated within the microcapsule 200. The liquid ion exchange chemicals 204 inside the polymer coat 202 provide small beads which behave as solids but have much higher exchange capacity, up to twice that of the art porous beads 100 illustrated in FIGS. 1A and 1B. The conventional media are limited by the number of binding sites on the porous support, typical no more than 2 meq/ml (mille-equivalent of the functional group per ml of solid media), or about 2 moles of capacity per liter of media. Applicants have successfully created the liquid-encapsulated media containing 30% dissolved amine (monoethanolamine, MEA), which is 300 g/kg or roughly 5 moles per liter of liquid. Consideration of the polymer volume and unfilled space between beads would reduce that concentration to around 4 moles per liter of encapsulated media, twice the maximum currently obtained in conventional media.

Microcapsule Making System

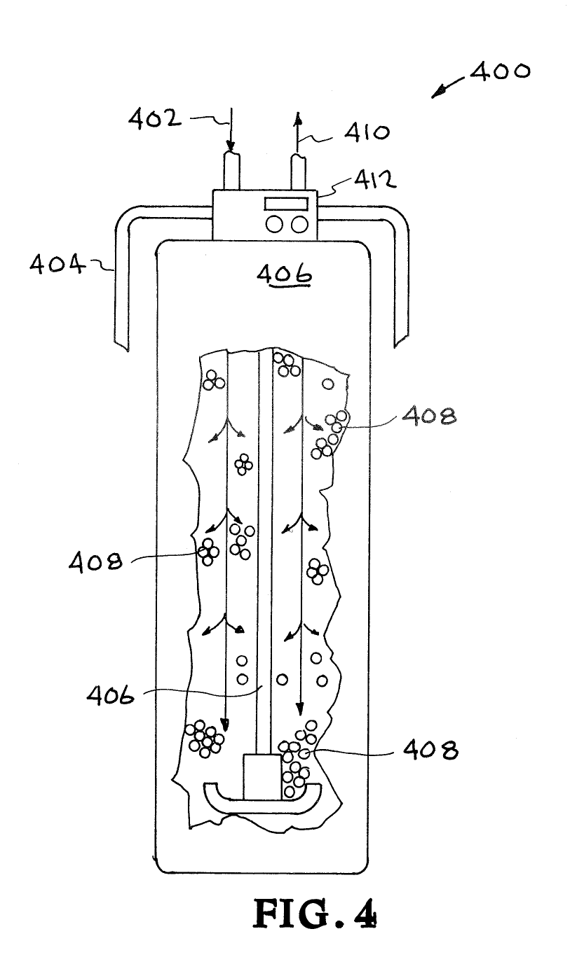

Referring now to FIG. 3 a system for making polymer coated microcapsules is illustrated. The system for making polymer coated microcapsules is designated generally by the reference numeral 300. The schematically illustrated system 300 will is composed of the following items. The injection tube 302 with a ID (um) and OD 1000 (um), a collection tube 304 with an ID of 500 (um) and OD 1000 (um) and an outer tube 306 of square cross section with ID of 1000 (um) and ID of 1200 (um).

In operation the inner fluid 308 (MEA/H2O) with a viscosity of 10-50 (cP) and a flow rate of 200-800 (Ulh-1) flows in the injection tube 302 in the direction indicated by arrow 310. As this fluid proceeds it passes thru a droplet forming nozzle 312. The formed droplet is released from the nozzle and becomes encased in the middle fluid 314 (NOA Pre-polymer) with a viscosity of 10-50 (cP) and flow rate of 200-800 (uLh-1), the middle fluid 314 is flowing in the direction indicated by arrow 316. The droplet in the middle fluid 314 becomes encased in the middle fluid 314 forming encapsulated microcapsules 318 that have liquid ion exchange chemicals in a core with a thin outer shell. The outer fluid (PVA Stabilizer) with a viscosity of 10-50 (cP) and a flow rate of 200-800 (uLh-1) flowing in the outer tube 306 in the direction indicated by arrow 322. This outer fluid 320 carries the fabricated microcapsules 318 into the collection tube 304. There is a boundary layer 324 that prevents the middle fluid 314 and outer fluid 320 from mixing as they have a large difference in both their viscosity and flow rates. The above described method will produce Microcapsules of a controlled size with an inner fluid liquid ion exchange chemicals enclosed in a shell.

Systems for producing microcapsules are described in U.S. Pat. No. 7,776,927 and in U.S. Published Patent Application Nos. 2009/0012187 and 2009/0131543. U.S. Pat. No. 7,776,927 to Liang-Yin Chu et al, assigned to the President and Fellows of Harvard College, discloses emulsions and the production of emulsions, including multiple emulsions and microfluidic systems for producing multiple emulsions. A multiple emulsion generally describes larger droplets that contain one or more smaller droplets therein which, in some cases, can contain even smaller droplets therein, etc. Emulsions, including multiple emulsions, can be formed in certain embodiments with generally precise repeatability, and can be tailored to include any number of inner droplets, in any desired nesting arrangement, within a single outer droplet. In addition, in some aspects of the invention, one or more droplets may be controllably released from a surrounding droplet. U.S. Published Patent Application No. 2009/0012187 to Liang-Yin Chu et al, assigned to the President and Fellows of Harvard College, discloses multiple emulsions, and to methods and apparatuses for making emulsions, and techniques for using the same. A multiple emulsion generally describes larger droplets that contain one or more smaller droplets therein which, in some cases, can contain even smaller droplets therein, etc. Emulsions, including multiple emulsions, can be formed in certain embodiments with generally precise repeatability, and can be tailored to include any number of inner droplets, in any desired nesting arrangement, within a single outer droplet. In addition, in some aspects of the invention, one or more droplets may be controllably released from a surrounding droplet. U.S. Published Patent Application No. 2009/0131543 to David A. Weitz discloses multiple emulsions, and to methods and apparatuses for making multiple emulsions. A multiple emulsion, as used herein, describes larger droplets that contain one or more smaller droplets therein. The larger droplet or droplets may be suspended in a third fluid in some cases. In certain embodiments, emulsion degrees of nesting within the multiple emulsion are possible. For example, an emulsion may contain droplets containing smaller droplets therein, where at least some of the smaller droplets contain even smaller droplets therein, etc. Multiple emulsions can be useful for encapsulating species such as pharmaceutical agents, cells, chemicals, or the like. In some cases, one or more of the droplets (e.g., an inner droplet and/or an outer droplet) can change form, for instance, to become solidified to form a microcapsule, a lipo some, a polymero some, or a colloidosome. As described below, multiple emulsions can be formed in one step in certain embodiments, with generally precise repeatability, and can be tailored to include one, two, three, or more inner droplets within a single outer droplet (which droplets may all be nested in some cases). As used herein, the term “fluid” generally means a material in a liquid or gaseous state. Fluids, however, may also contain solids, such as suspended or colloidal particles. U.S. Pat. No. 7,776,927 and U.S. Published Patent Application Nos. 2009/0012187 and 2009/0131543 are incorporated herein by this reference.

The present invention provides benefits in fabrication and manufacturability. The beads can be fabricated at a size small enough for efficient mass transfer and large enough for ease of handling. The present invention provides methods to fabricate liquid filled shells in the size range of 100 microns to 1 mm with wall thickness from 5-10 microns. The present invention provides benefits in survivability and robustness. The present invention identifies several polymers that can withstand typical regeneration temperatures of 100-120° C. In addition, the selected polymers will be capable of withstanding small volumetric changes. The polymers can be made of various polymers including polymers made of Poly(1-trimethylsilyl propyne), Vinyl alcohol/acrylate copolymer, Polydimethylsiloxane (PDMS), Teflon AF, Polyimide with 6FDA groups, Cellulose acetate, and Poly(vinyl alcohol).

The present invention is further explained by a number of examples. The examples further illustrate Applicants' system of ion exchange media created by encapsulating liquid ion exchange chemicals inside a polymer coat. The microcapsules have a polymer coating with ion exchange media encapsulated within the microcapsules. The present invention provides a new form of ion exchange media that can be used in water purification, water softening, purifying metals including radionuclides, making very high purity water for reactors and boilers, purifying pharmaceuticals, refining sugar and food additives, specialized purification processes such as refining metals and radionuclides, carbon dioxide sequestering, and other uses.

### EXAMPLE 1

### Water Softening

Water softening is the reduction of the concentration of calcium, magnesium, and certain other metal cations in hard water. These “hardness ions” can cause a variety of undesired effects including interfering with the action of soaps, the build up of limescale, which can foul plumbing, and galvanic corrosion. Water softening methods mainly rely on the removal of Ca²⁺ and Mg²⁺ from a solution or the sequestration of these ions, i.e. binding them to a molecule that removes their ability to form scale or interfere with soaps. Removal is achieved by ion exchange and by precipitation methods. Sequestration entails the addition of chemical compounds called sequestration (or chelating) agents.

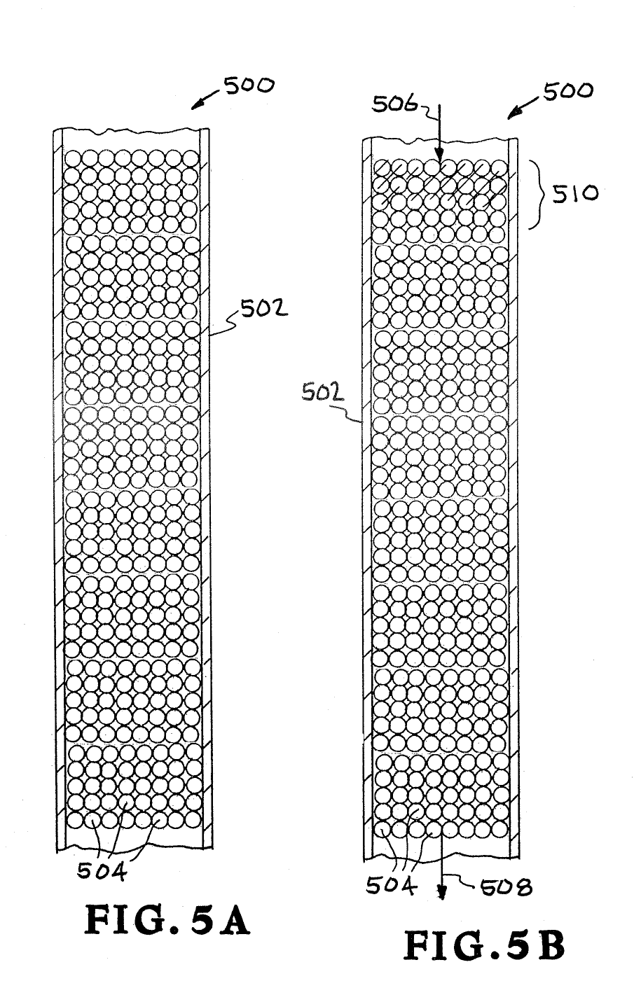

Referring to FIG. 4, a water softening system using Applicant's microcapsules that encapsulate liquid ion exchange chemicals inside a polymer coat making small beads which behave as solids but have much higher exchange capacity. The water softening system is designated generally by the reference numeral 400. A water supply 402 introduces hared water to a mineral tank 406. The system 400 includes a drain 404, a mineral tank 406, an outlet manifold 406, a line 410 directing water to the user, and a timer and valve assembly 412. The water to be treated passes through a bed of plastic beads 408 having the resin. Negatively charged resins absorb and bind metal ions, which are positively charged. The resins initially contain univalent (1+) ions, most commonly sodium, but sometimes also hydrogen (H⁺) or potassium (K⁺). Divalent calcium and magnesium ions in the water replace these univalent ions, which are released into the water. The “harder” the water, the more hydrogen, sodium or potassium ions are released from the resin and into the water.

Conventional water-softening appliances intended for household use depend on an ion-exchange resin in which hardness ions are exchanged for sodium ions. Ion-exchange water softeners depend on two tanks, the resin and brine tanks, remove calcium and magnesium ions from the water. Resin beads reside within the resin tank where potentially-hard water will pass through. The resin tank exchanges softer, resin beads (bound with sodium ions) with those ions that make water hard. When the beads have taken all the calcium and magnesium ions and the tank is full, the ion-exchange softener goes offline. Salt water from the brine tank, filled with new sodium ions ready for exchange, flushes the resin tank and the resin tank comes back online.

### EXAMPLE 2

### Ion Exchange Resins Used in Columns

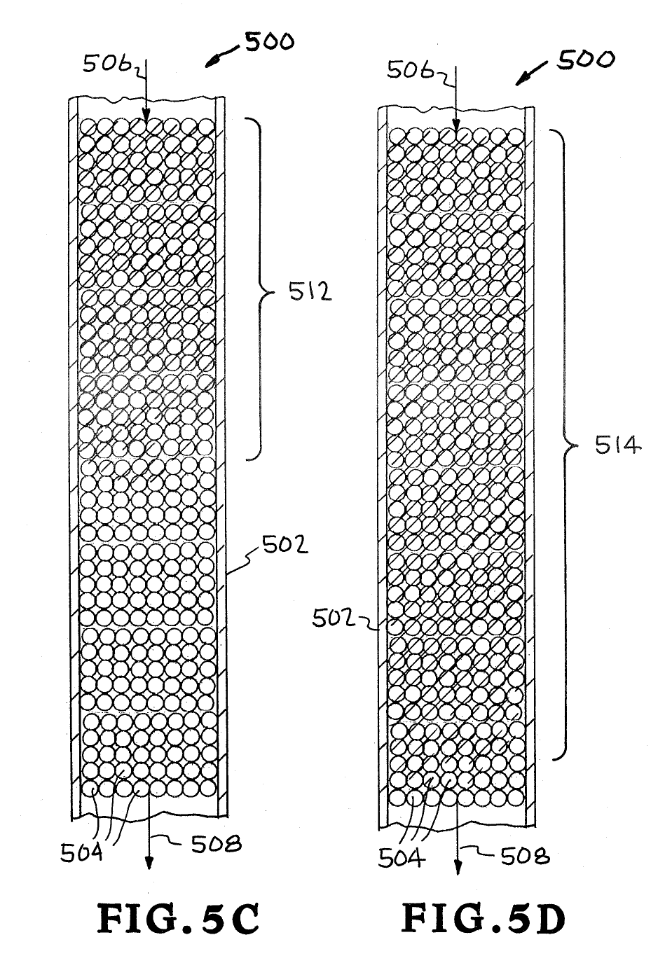

In the laboratory as well as in industrial plants, ion exchange resins are used in columns. The water or solution to be treated flows through a column containing ion resin beads. Referring to FIGS. 5A, 5B, 5C, and 5D, a column system using Applicant's microcapsules that encapsulate liquid ion exchange chemicals inside a polymer coat making small beads which behave as solids but have much higher exchange capacity. The column system is designated generally by the reference numeral 500. A water or solution to be treated 506 introduces the water or solution to be treated 506 into the column 502 containing Applicant's microcapsules that encapsulate liquid ion exchange chemicals inside a polymer coat making small beads 504 which behave as solids but have much higher exchange capacity.

The column 502 containing Applicant's microcapsules that encapsulate liquid ion exchange chemicals inside a polymer coat making small beads 504 which behave as solids but have much higher exchange capacity is illustrated in FIG. 5A. In FIGS. 5B and 5C you see the fresh resin beads, then you see how the resin beads get progressively loaded with the ions from the feed solution in the sections 510 and 512. As illustrated in FIG. 5D, at the end the entire column 502 is loaded as represented by the section 514 and operation is stopped. The column system 500 can be used for softening of beet sugar juices before evaporation, colour removal from cane sugar syrups, chromatographic separation of glucose and fructose, demineralisation of whey, glucose and many other foodstuffs, recovery of polyphenols for use in the food industry, recovery of uranium from mines, recovery of gold from plating solutions, separation of metals in solution, catalysis of anti-knocking petrol additives, extraction of antibiotics and other compounds from fermentation broths, purification of organic acids, powdered ion exchange resin is used in tablets in the pharmaceutical industry, and other uses.

### EXAMPLE 3

### Ion Exchange Resins Used for Metals Recovery

Applicant's microcapsules that encapsulate liquid ion exchange chemicals inside a polymer coat making small beads which behave as solids but have much higher exchange capacity can be used for metals recovery from mines and mine waste streams. Applicant's microcapsules can be used as ion exchange resins to clean up mine drainage and capture marketable amounts of metals (copper and cobalt in this example). Increased capacity and increased uptake rates of Applicant's microcapsules would improve the overall process economics. This is also done for uranium, gold, nickel, chrome and others. Applicant's microcapsules can be used as the same chemical functional group as is used in the conventional resin and encapsulate it up to full strength in our bead and use in a similar capture process. Applicant's microcapsules can be used for uranium, gold, nickel, chrome and others.

Ion exchange involves the interchange (or exchange) of ions between a solid media and mining-influenced water (MIW). The solid media can be commercially produced or made from naturally occurring substances (e.g., peat or zeolites). Various resin forms are available to remove either cations or anions. Synthetic organic resins are the predominant type since their characteristics can be tailored to specific applications.

The capacity of any resin is limited and is a function of the resin, the number of available exchange sites, and the input water chemistry. Capacity is generally estimated in pounds of contaminant removed per cubic foot of resin. Once all the available sites are used, the resin must be regenerated, either on or off site. Depending on the type of water that is to be treated, selective metal recovery may be an option.

### EXAMPLE 4

### Ion Exchange Resins Used for Radionuclide Separation

Applicant's microcapsules that encapsulate liquid ion exchange chemicals inside a polymer coat making small beads which behave as solids but have much higher exchange capacity can be used for radionuclide separation in radioactive waste processing. Ion exchange is commonly used in processes to separate radioactive wastes, in particular for radium separation from actinides. In Applicant's case, Applicant may be able to use more radiation-tolerant capsules than is possible with conventional resins. This has addition advantages of increased capacity and faster kinetics. A corollary of this is capsules designed for rare earth metals separation, currently a topic of great interest because of the rare earth metals shortage and the Chinese domination of this market. An example is disclosed in United States Published Patent Application No. 2010/0018347 for separation of radium and rare earth elements from monazite.

### EXAMPLE 5

### Directing Capsules Into the Fluid

This embodiment of the present invention provides a method of processing a fluid using ion exchange chemicals wherein the capsules are directed into the fluid. Ion exchange media is created by encapsulating liquid ion exchange chemicals inside a polymer coat, making small capsules which behave as solids but have much higher exchange capacity, up to twice that of existing media. The small capsules are directed into the fluid being processed.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A capsule for encapsulating ion exchange chemicals, comprising:
a capsule body, including
a surface layer, and
ion exchange chemicals encapsulated within said surface layer.

2. The capsule for encapsulating ion exchange chemicals of claim 1 wherein said surface layer is made of a porous solid.

3. The capsule for encapsulating ion exchange chemicals of claim 1 wherein said surface layer is made of any of several families of polymers, including polystyrene, polyethylene, polypropylene, silicones, and nylon.

4. The capsule for encapsulating ion exchange chemicals of claim 1 wherein said ion exchange chemicals are liquid.

5. A capsule apparatus for encapsulating ion exchange chemicals, comprising:
capsule body means for encapsulating ion exchange chemicals,
surface layer means for encapsulating ion exchange chemicals, and
ion exchange chemical means encapsulated within said surface layer.

6. The capsule apparatus for encapsulating ion exchange chemicals of claim 5 wherein said surface layer means is a porous solid.

7. The capsule apparatus for encapsulating ion exchange chemicals of claim 5 wherein said surface layer means is made of any of several families of polymers, including polystyrene, polyethylene, polypropylene, silicones, and nylon.

8. The capsule apparatus for encapsulating ion exchange chemicals of claim 5 wherein said ion exchange chemical means are liquid chemicals.

9. An apparatus for encapsulating ion exchange chemicals, comprising:
microcapsules having a capsule body,
each of said microcapsules having a surface layer, and
ion exchange chemicals encapsulated within said surface layer.

10. The An apparatus for encapsulating ion exchange chemicals of claim 9 wherein said surface layer is made of a porous solid.

11. The An apparatus for encapsulating ion exchange chemicals of claim 9 wherein said surface layer is made of any of several families of polymers, including polystyrene, polyethylene, polypropylene, silicones, and nylon.

12. The An apparatus for encapsulating ion exchange chemicals of claim 9 wherein said ion exchange chemicals are liquid.

13. A method of processing a fluid using ion exchange chemicals, comprising the steps of:
providing capsules having a capsule body with a surface layer and with the ion exchange chemicals encapsulated within said surface layer, and
processing the fluid by interacting the fluid and said capsules having a capsule body with a surface layer and with the ion exchange chemicals encapsulated within said surface layer.

14. The method of processing a fluid using ion exchange chemicals of claim 13 wherein said step of providing capsules having a capsule body with a surface layer and with the ion exchange chemicals encapsulated within said surface layer comprises providing capsules having a capsule body with a surface layer made of any of several families of polymers, including polystyrene, polyethylene, polypropylene, silicones, and nylon and with the ion exchange chemicals encapsulated within said surface layer made of any of several families of polymers, including polystyrene, polyethylene, polypropylene, silicones, and nylon.

15. The method of processing a fluid using ion exchange chemicals of claim 13 wherein said step of providing capsules having a capsule body with a surface layer and with the ion exchange chemicals encapsulated within said surface layer comprises providing capsules having a capsule body with a surface layer and with liquid ion exchange chemicals encapsulated within said surface layer.

16. The method of processing a fluid using ion exchange chemicals of claim 13 wherein said step of processing the fluid by interacting the fluid and said capsules comprises directing the fluid onto said capsules.

17. The method of processing a fluid using ion exchange chemicals of claim 13 wherein said step of processing the fluid by interacting the fluid and said capsules comprises directing said capsules onto the fluid.

18. The method of processing a fluid using ion exchange chemicals of claim 13 wherein said step of processing the fluid by interacting the fluid and said capsules comprises directing the fluid into a column containing said capsules.

19. The method of processing a fluid using ion exchange chemicals of claim 13 wherein the method is a method of water softening and wherein said step of providing capsules having a capsule body with a surface layer and with the ion exchange chemicals encapsulated within said surface layer comprises providing capsules having a capsule body with a surface layer and with sequestration or chelating agents encapsulated within said surface layer; and wherein said step of processing the fluid by interacting the fluid and said capsules having a capsule body with a surface layer and with the ion exchange chemicals encapsulated within said surface layer comprises processing the fluid by interacting the fluid and said capsules having a capsule body with a surface layer and with sequestration or chelating agents encapsulated within said surface layer for water softening.

20. The method of processing a fluid using ion exchange chemicals of claim 13 wherein the method is a method of softening of beet sugar juices before evaporation, colour removal from cane sugar syrups, chromatographic separation of glucose and fructose, demineralisation of whey, glucose and many other foodstuffs, recovery of polyphenols for use in the food industry, recovery of uranium from mines, recovery of gold from plating solutions, separation of metals in solution, catalysis of anti-knocking petrol additives, extraction of antibiotics and other compounds from fermentation broths, purification of organic acids, or providing powdered ion exchange resin for making tablets in the pharmaceutical industry and wherein said step of providing capsules having a capsule body with a surface layer and with the ion exchange chemicals encapsulated within said surface layer comprises providing capsules having a capsule body with a surface layer and with ion exchange resins encapsulated within said surface layer; and wherein said step of processing the fluid by interacting the fluid and said capsules having a capsule body with a surface layer and with ion exchange resins encapsulated within said surface layer comprises processing the fluid by interacting the fluid and said capsules having a capsule body with a surface layer and with ion exchange resins encapsulated within said surface layer for softening of beet sugar juices before evaporation, colour removal from cane sugar syrups, chromatographic separation of glucose and fructose, demineralisation of whey, glucose and many other foodstuffs, recovery of polyphenols for use in the food industry, recovery of uranium from mines, recovery of gold from plating solutions, separation of metals in solution, catalysis of anti-knocking petrol additives, extraction of antibiotics and other compounds from fermentation broths, purification of organic acids, or providing powdered ion exchange resin for making tablets in the pharmaceutical industry.
